(19) United States
(12) Patent Application Publication
(10) Pub. No.: US 2012/0180748 A1
(43) Pub. Date: Jul. 19, 2012

(54) PROTECTIVE LAYER AGAINST HOT GAS CORROSION IN THE COMBUSTION CHAMBER OF AN INTERNAL COMBUSTION ENGINE

(75) Inventor: Gunter BURKLE, Benningen (DE)

(73) Assignee: KS Kolbenschmidt GmbH

(21) Appl. No.: 13/428,745

(22) Filed: Mar. 23, 2012

Related U.S. Application Data
(63) Continuation of application No. 11/816,364, filed on Aug. 15, 2007, now abandoned.

(30) Foreign Application Priority Data
Feb. 15, 2005 (DE) DE102005006671.2

(51) Int. Cl. F02F 3/00; C09D 7/12; B82Y 30/00

(52) U.S. Cl. 123/193.6; 106/14.41; 977/773

(57) ABSTRACT

A coating for a tribologically heavily loaded component, wherein the coating is in the form of a ceramic coating made of an organic-inorganic prepolymer which is pyrolyzed after being applied to the component.

### CROSS REFERENCE TO CO-PENDING APPLICATION

This application is a continuation of co-pending U.S. application Ser. No. 11/816,364, filed Aug. 15, 2007 in the name of Gunter Burkle, for a Protective Layer Against Hot Gas Corrosion in the Combustion Chamber of an Internal Combustion Engine, the entire contents of which are incorporated herein in its entirety.

### BACKGROUND

The surfaces in the combustion chamber of an internal combustion engine over which hot combustion gases pass tend fundamentally to oxidation. Especially affected thereby are the crowns of the pistons of the internal combustion engine. Regardless of the type of piston construction, this oxidation occurs with steel and light-weight pistons. Because of the resulting hot gas corrosion and the resulting thermo-mechanical stress on the areas of the piston crown, in particular, the edge areas if the piston has a combustion bowl, fractures occur in the area of the piston crown.

Steps have already been taken to counter this, which so far have all been unsatisfactory. A temperature-stable, high-temperature paint on the basis of polyphosphates, chromates and aluminum powder is known from DE 196 29 399 A1 but which, because of environmental regulations, is difficult to handle in a production process. A multi-layer coat of different materials consisting of undercoat, middle coat and topcoat is known from DE 40 03 038 C1 which is laborious to apply in the production of a piston. Plasma-sprayed coats are known from DE 198 52 285 C2 which are also time-consuming in production. From DE 198 52 285 C2 it is known to conform the coefficients of thermal expansion of glass, metal and ceramics by a suitable process, wherein no reference is made to internal combustion engines.

### SUMMARY

A coating for a tribologically heavily loaded component is disclosed which creates a high-temperature resistant corrosion protection layer for the component. The coating is a ceramic coating made of an organic prepolymer which is pyrolyzed after being applied to the component.

### DETAILED DESCRIPTION

A coating for a tribologically heavily loaded component is disclosed, the result of which is a high-temperature resistant corrosion protection layer for the component.

The coating is a ceramic coating made of an organic prepolymer which is pyrolyzed after being applied to the component.

The metals can be from the group Si (silcon), Ti (titanium), Zr (zirconium), Al (aluminum), Sn (tin) or Ce (cerium), for example. These metals are converted completely or partially into oxides in the course of pyrolysis at temperatures found particularly in the combustion chamber between 200° C. and 450° C. and sintered to each other so the high-temperature resistant protective layer against hot gas corrosion is created. Thus, the coating is pyrolyzable metal-alkoxides and or organo-metallic compounds in organic solvents.

A thin coating of the organic-inorganic prepolymer is applied to the component which then undergoes pyrolysis. The coating is on the one hand very thin, and on the other hand the pyrolysis process does not have to be performed during production of the component but can be carried out after installation of the component and the start of operation. When using the coating on a piston for an internal combustion engine, the coating can be applied at the piston manufacturer while the actual pyrolysis does not take place until the piston is installed in the internal combustion engine and the engine has started operation. After the initial combustion events, the coating is pyrolized and offers a high-temperature resistant protection layer for the piston crown from hot gas corrosion in the combustion chamber of the internal combustion engine so that the service life of the piston is substantially increased.

In a method of applying the coating, it must be remembered that the entire piston crown, regardless of whether it has a combustion bowl or not, is given the coating. If the piston has a combustion bowl, consideration can be given to coating only the combustion bowl completely or even only the edge areas of the combustion bowl in order to protect the area stressed by the hot gas corrosion effectively.

In the oxidic matrix, the oxidation-resistant metallic particles admixed into the precursors can consist of Al, Cu, Fe, Cr, Ni or Co, where here the list is not complete. In addition, an alloy of the metallic particles named can be used which serve to conform the coefficients of thermal expansion and act as fillers to prevent shrinkage cracks during pyrolysis. By admixing the materials named, on the one hand the coefficient of thermal expansion of the coating is conformed to the material of the component and on the other hand material stresses, in particular shrinkage cracks, are effectively prevented.

In a further aspect, paint pigments are admixed to the coating. It is self-evident that the admixed paint pigments are also heat-resistant. For example, black or other dark pigments can be used to increase radiation absorption, resulting in improved heat dissipation.

In a further aspect, metallic pigments are admixed to the coating. Such metallic pigments serve to increase the degree of reflection, and thereby effectively prevent hot gas corrosion through the reduction in component temperature. In addition, the coefficients of thermal expansion of the component and the coating can be conformed to each other through the metallic pigments so that thermal stresses between the coating and the component are reduced.

In a further aspect, ceramic fillers (particles) are admixed to the coating. These ceramic fillers (in particular, nanoparticles) increase the lubricity of the coating so that not only is hot-gas corrosion prevented but the friction of the coating is lowered.

In a further aspect, several of the aforementioned types of pigment can be combined with each other.

A simple and cost-effective production process consists of applying the coating to the component, for example, by spraying, immersion, application by doctor blade or similar. Then the component is dried, wherein either after drying, the component undergoes heat treatment whereby the coating is pyrolyzed. However, this can be omitted at the manufacturer of the component, in particular of the piston, if the component is being delivered to the one who installs it and then undergoes heat treatment in its operating condition. Thus, it is normally the case that a supplier to an automobile maker produces pistons, gives them the disclosed coating which is initially only dried. When the piston is delivered to the automobile maker, or the manufacturer of the internal combustion engine, it can be installed whereupon the pyrolysis of the coating takes place the first time the internal combustion engine is started. No additional steps for pyrolysis are then necessary so that the high-temperature resistant corrosion protection layer is available immediately when the internal combustion engine commences operation.

What is claimed is:

1. A coating for a tribologically heavily loaded component comprising: a ceramic coating made from at least one of pyrolyzable metal-alkoxides and pyrolyzable organo-metallic compounds in organic solvents which is pyrolyzed after it is applied to the component.

2. The coating of claim 1, further comprising metallic pigments admixed with the organic-inorganic prepolymer prior to pyrolysis.

3. The coating of claim 1, further comprising paint pigments admixed with the organic-inorganic prepolymer prior to pyrolysis.

4. The coating of claim 1, further comprising ceramic particles admixed with the organic-inorganic prepolymer prior to pyrolysis.

5. The coating of claim 1 further comprising at least two of metallic pigments, paint pigments, and ceramic particles admixed with the organic-inorganic prepolymer prior to pyrolysis.

6. A piston for an internal combustion engine, comprising a piston crown having the coating in accordance with claim 1.

7. A piston for an internal combustion engine, comprising a combustion bowl having an edge, and the coating in accordance with claim 1, wherein the coating coats at least the combustion bowl edge.

8. The piston of claim 8 for an internal combustion engine, wherein the coating coats the entire combustion bowl.

9. The coating of claim 1 further comprising ceramic nanoparticles admixed with the organic-inorganic prepolymer prior to pyrolysis.

10. A piston for an internal combustion engine having at least one of a piston crown of the piston, and a combustion bowl edge of a combustion bowl in the piston crown comprising:
a ceramic coating made from at least one of pyrolyzable metal-alkoxides and pyrolyzable organo-metallic compounds in organic solvents which is pyrolyzed after it is applied to at least one of a piston crown of a piston, a combustion bowl edge of a combustion bowl in the piston crowns and the entire combustion bowl in the piston crown.

11. The piston of claim 10 wherein the coating further comprises
at least one of metallic pigments, paint pigments, and ceramic particles admixed with the organic-inorganic prepolymer prior to pyrolysis.

12. The piston of claim 10 wherein the coating further comprises
at least two of metallic pigments, paint pigments, and ceramic particles admixed with the organic-inorganic prepolymer prior to pyrolysis.
